(19) United States
(12) Patent Application Publication
(10) Pub. No.: US 2010/0190098 A1
(43) Pub. Date: Jul. 29, 2010

(54) INFRARED ENDPOINT DETECTION FOR PHOTORESIST STRIP PROCESSES

(75) Inventors: QUENTIN E. WALKER, Fremont, CA (US); MATHEW F. DAVIS, Felton, CA (US); DANNY CHIEN LU, Gilroy, CA (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 12/360,701

(22) Filed: Jan. 27, 2009

(51) Int. Cl. G03C 5/00

(52) U.S. Cl. 430/30

(57) ABSTRACT

Methods and apparatus for monitoring and detecting absorbed infrared radiation endpoint(s) are provided herein. In some embodiments, a method for determining an endpoint of a photoresist removal process may include removing a photoresist from a substrate disposed in a process chamber using reactive species provided to the process chamber from a remote plasma source. Infrared radiation is directed into the at least one of the reactive species or process byproducts while removing the photoresist. A quantity of infrared radiation absorbed by at least one of the reactive species or process byproducts during the removal process is monitored. The photoresist removal process may be ended based upon the monitored quantity reaching a predetermined level.

### BACKGROUND

1. Field

Embodiments of the present invention relate generally to methods and apparatus for semiconductor substrate processing, and more specifically, to methods and apparatus for endpoint detection for substrate processing.

2. Description of Related Art

As a part of semiconductor manufacturing, various layers of dielectric, semiconducting, and conducting films, such as silicon dioxide, polysilicon, and metal compounds and alloys, are deposited on a silicon substrate. Features are defined in these layers by processes such as lithography and etching. Such processes may include coating a substrate with photoresist, patterning the photoresist, and then transferring this pattern to the underlying layers by etching the substrate while using the patterned photoresist as an etch mask. Upon completion of etching, the photoresist must be removed, or stripped, from the substrate. In addition, many of these etch processes leave photoresist and post-etch residues on the substrate that must be removed before performing the next process step.

During photoresist and/or residue removal processing, optical emission spectroscopy is commonly used to detect the process endpoint. Such processes rely upon detecting the optical emissions generated by process gases and/or byproducts in an excited electrical state due to the plasma. However, as the critical dimensions of semiconductor devices become smaller, a need has arisen to perform photoresist and post-etch residue removal processes at reduced temperatures in order to prevent defects such as, for example, diffusion between adjacent structures formed on the substrate. One suitable reduced temperature process utilizes a remote plasma chamber wherein the plasma is formed outside the processing volume, thereby reducing the processing temperatures within the process chamber. Unfortunately, however, because the plasma is produced outside the processing volume, optical emission endpoint detection is compromised due to the process gases and/or byproducts no longer being in an excited state within the process chamber.

Therefore, there is a need in the art for a method and apparatus for performing endpoint detection for remote plasma processes, such as photoresist strip and/or residue removal.

### SUMMARY

Methods and apparatus for monitoring and detecting absorbed infrared radiation endpoint(s) are provided herein. In some embodiments, a method for determining an endpoint of a photoresist removal process may include removing a photoresist from a substrate disposed in a process chamber using reactive species provided to the process chamber from a remote plasma source. Infrared radiation is directed into the at least one of the reactive species or process byproducts while removing the photoresist. A quantity of infrared radiation absorbed by at least one of the reactive species or process byproducts during the removal process is monitored. The photoresist removal process may be ended based upon the monitored quantity reaching a predetermined level.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram of a method for determining a process endpoint in accordance with some embodiments of the present invention.

FIG. 2 is a schematic diagram of one embodiment of an illustrative chamber used to perform the method of the present invention.

FIG. 3 is a schematic diagram of one embodiment of an illustrative infrared radiation spectroscopy system used to perform the method of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods and apparatus for monitoring and detecting absorbed infrared (IR) radiation endpoint(s) are provided herein. More particularly, IR radiation endpoint(s) can be IR radiation absorbed by byproducts during photoresist stripping and/or removal of residues from a substrate. The inventive methods may be advantageously provided in process chambers wherein reactive species and byproducts may be unable to generate suitable optical emission signatures (for example, due to not being in an energized state). Such process chambers can illustratively include process chambers having remote plasma sources.

In some embodiments, IR radiation absorbed by process gases and/or byproducts may be utilized for identifying an endpoint of a photoresist removal process. In some embodiments, the photoresist removal process may include removing a photoresist from a substrate disposed in a process chamber using reactive species provided to the process chamber from a remote plasma source.

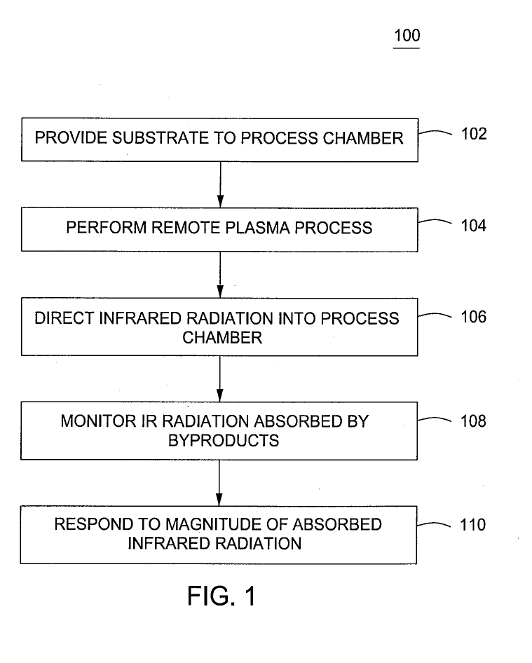

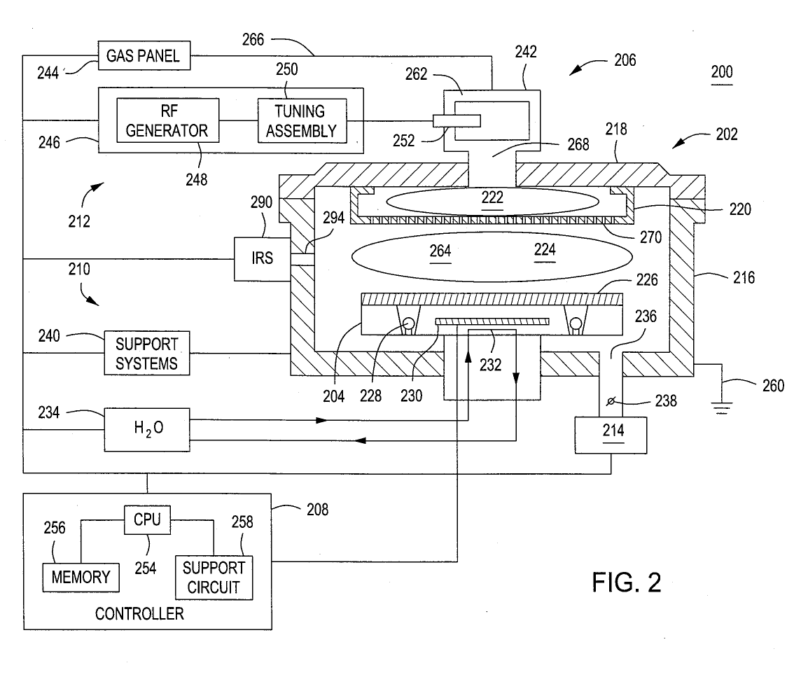

FIG. 1 is a flow diagram of an exemplary method 100. The method begins at 102 where a substrate is provided to a process chamber having a remote plasma source for providing reactive species to an interior volume the process chamber in a non-plasma state. In some embodiments, the process chamber may be configured to perform photoresist stripping and/or residue removal processes. One such suitable chamber is manufactured under the trademark AXIOM™ by Applied Materials, Inc., of Santa Clara, Calif., and is described below with respect to FIG. 2.

At 104, the substrate is processed, for example, to remove photoresist and/or to remove post-etch residues from prior processing of the substrate (including from a prior photoresist removal process). In some embodiments, the process may be a photoresist and/or residue removal process utilizing reactive species provided from a remote plasma source. In some embodiments, for example to remove photoresist, an oxygen-based plasma may be used. For example, a process gas (or gaseous mixture) may be provided to a remote plasma source at a flow rate of between about 100 to about 10,000 sccm. The process gas may include one or more oxidizing gases, such as oxygen (O₂), ozone (O₃), nitric oxide (N₂O), nitrous oxide (NO₂), water (H₂O) vapor, alcohols, and the like. In some embodiments, the process gas may further include one or more non-oxidizing gases provided at a flow rate of between about 100 to about 10,000 sccm. The one or more non-oxidizing gases may include nitrogen (N₂), hydrogen (H₂), forming gas (up to about 5% hydrogen mixed with nitrogen), ammonia (NH₃), methane (CH₄), C₂H₆, halogenated gases (CF₄, NF₃, C₂F₆, C₄F₈, CH₃F, CH₃F₂, CHF₃), and the like.

The process gas may be formed into a plasma in the remote plasma source by applying up to about 8000 Watts of RF energy. The reactive species formed in the remote plasma source may then be directed to the process chamber. In some embodiments, the pressure in the chamber may be maintained at between about 0.001 to about 100 Torr. The temperature of the substrate may be maintained at a temperature of between about 15 to about 300 degrees Celsius.

Next, at 106, IR radiation is directed into the process gases (e.g., the process gases and/or reactive species and/or any process byproducts) in the process chamber (or into a sample of process gases from the process chamber). The IR radiation may be provided by any IR radiation source suitable for providing IR radiation having a wavelength that may be absorbed by the process gases and/or byproducts of the process. As used herein, IR radiation “absorbed by the process gases” includes IR radiation absorbed by reactive species and/or neutrals provided by the remote plasma source and IR radiation absorbed by process byproducts, as well as by the process gas as a whole (e.g., although IR absorption characteristics may vary for molecular process gas compositions, reactive species of the process gas composition, neutrals of the process gas composition, and process byproducts formed during processing, the phrase absorbed by the process gas is used for convenience to include all of the above). Such IR radiation sources may include, for example, broadband or laser IR sources, as discussed below with respect to FIG. 2. The IR radiation may be directed into the process gases by directing IR radiation into the process chamber or by sampling process gases from the process chamber or chamber exhaust. Directly sampling process gases allows for the detection of species having a low concentration (e.g., having a part per million, ppm, range or lower).

At 108, the IR radiation absorbed by the process gases and/or byproducts of the process may be monitored. The process gases and/or byproducts may be monitored utilizing an IR detector. The IR detector may be disposed in any suitable location for detecting the IR radiation absorbed by the process gases and/or byproducts. For example, the IR detector may be coupled to the process chamber, disposed in or above the exhaust line, or the like, as described below with respect to FIG. 2. In some embodiments, the IR radiation absorbed by the process gases and/or byproducts may be monitored by sampling at a suitable rate. In some embodiments, the IR radiation absorbed may be sampled at an illustrative rate of about 1 Hz, although faster or slower sampling rates may be utilized.

The IR detector may provide a signal to a controller that can analyze the signal. The controller may be part of the IR detector or may be a separate controller coupled thereto. In some embodiments, the controller may analyze the signal to determine an absolute molar concentration of the process gas and/or byproduct components of interest. For example, at a known pressure and temperature, the absolute molar concentration of the process gas and/or byproduct components of interest may be calculated using Beer-Lambert's Law. In some embodiments, IR radiation absorbed at a single wavelength may be monitored. In some embodiments, IR radiation absorbed at a plurality of wavelengths may be monitored. The plurality of wavelengths may correspond to IR radiation absorption characteristics of multiple process gases or byproducts of the process being performed.

At 110, a decision is made to continue processing, to modify processing, or to end processing, in response to the magnitude of IR radiation absorbed. The decision may be made by comparing the magnitude of IR radiation absorbed to one or more setpoints, for example, stored in a controller of the IR radiation apparatus or the process chamber. The one or more setpoints may correspond to a quantity of process gas, constituent, and/or byproduct present in the process gas sample. The one or more setpoints may further correspond to a process endpoint, a process change (such as when processing with multiple-step recipes that may include initial etch, main etch, overetch stages, or the like), or the like. The one or more setpoints may also correspond to an absolute magnitude of the IR radiation absorbed (such as reaching a certain level), a change in the magnitude of the IR radiation absorbed (such as a sudden increase or decrease), or the like. The correlation between the quantity of IR radiation absorbed (and/or the absolute molar concentration of the process gas and/or byproduct) and the process progress or state may be modeled or determined empirically in order to determine when to alter the process or cease processing altogether.

For example, in some embodiments, the chamber parameters, (e.g., gases, power levels, pressure, temperature and the like) may be altered upon detecting a change in the magnitude of IR radiation absorbed by process gases or byproducts of the process. As such, the magnitude of IR radiation absorbed by the process gases and/or byproducts can be used to optimize processing, to modify processing, to switch between process steps, and/or to cease processing (for example, when photoresist and/or residues are suitably removed). In embodiments where a decision is made to continue processing (such as where an endpoint level has not been detected), the method 100 may continue by continuing to direct IR radiation into the process chamber and monitoring the IR radiation absorbed as discussed above. Upon making a decision to end processing, the method 100 generally ends and the substrate may be further processed as desired.

In one exemplary process, a photoresist may be stripped from a wafer in a remote plasma chamber utilizing a process gas comprising carbon monoxide (CO), carbon dioxide (CO₂), or water (H₂O) vapor. IR radiation may be directed into a sample of the process gases and the IR absorption may be monitored at a sample rate of, for example, 1 Hz to create an endpoint trace. The IR absorption over time may be monitored to determine a process endpoint. The IR radiation absorbed can be monitored between suitable ranges, such as 2000-2300 cm⁻¹ for carbon monoxide (CO), 2200-2400 cm⁻¹ for carbon dioxide (CO₂), and either 1300-2200 cm⁻¹ or 2800-4200 cm⁻¹ for water (H₂O) vapor. A minimum quantity of byproduct may be required for endpoint detection. The minimum quantity may scale with the partial pressure of each byproduct present in the process gas sample. In some embodiments, the minimum quantity may be 100 ppm for carbon monoxide (CO), 1500 ppm for carbon dioxide (CO₂), and 5000 ppm for water (H₂O) vapor when the chamber pressure is maintained at about 2 Torr.

While the inventive methods described herein pertain to monitoring the IR radiation absorbed by process gases or byproducts of a photoresist removal and/or residue removal process, other processes having process gases and/or byproducts capable of absorbing IR radiation and whose quantity may vary relative to the processing stage may be suitable controlled using the inventive methods disclosed herein. In addition, the inventive methods described herein may be used to advantage utilized in other processes utilizing remote plasma sources, where the process gases and byproducts are not in a highly energized state.

Exemplary methods in accordance with the present invention may be used on a variety of systems having IR source and detection hardware as described below. FIG. 2 depicts a schematic diagram of one suitable reactor (or chamber) 200 that may be used to practice embodiments of the method 100, described above. The reactor 200 is similar to the AXIOM™ reactor, commercially available from Applied Materials, Inc. or Santa Clara, Calif. The AXIOM reactor is further described in detail in U.S. patent application Ser. No. 10/264,664, filed Oct. 4, 2002, which is incorporated herein by reference.

The reactor 200 comprises a process chamber 202, a remote plasma source 206, an IR radiation spectroscopy (IRS) system 290, and a controller 208. The process chamber 202 is generally a vacuum vessel, which comprises a first portion 210 and a second portion 212. In one embodiment, the first portion 210 comprises a substrate support 204, a sidewall 216 and a vacuum pump 214. The second portion 212 comprises a lid 218 and a gas distribution plate (showerhead) 220, which defines a gas mixing volume 222 and a reaction volume 224. The lid 218 and sidewall 216 are generally formed from a metal (e.g., aluminum (Al), stainless steel, and the like) and electrically coupled to a ground reference 260.

The substrate support 204 supports a substrate (wafer) 226 within the reaction volume 224. In some embodiments, the substrate support 204 may comprise a source of radiant heat, such as gas-filled lamps 228, as well as an embedded resistive heater 230 and a conduit 232. The conduit 232 provides cooling water from a source 234 to the backside of the substrate support 204. The substrate may be retained on the substrate support by gravity, mechanical clamping, vacuum clamping, electrostatic clamping, or the like. Gas conduction may transfer heat from the substrate support 204 to the substrate 226. The temperature of the substrate 226 may illustratively be controlled between about 20 and 400 degrees Celsius.

The vacuum pump 214 is coupled to an exhaust port 236 formed in the sidewall 216 of the process chamber 202. The vacuum pump 214 is used to maintain a desired gas pressure in the process chamber 202, as well as evacuate the post-processing gases and other volatile compounds from the chamber. In some embodiments, the vacuum pump 214 may be augmented with a throttle valve 238 to further control the gas pressure in the process chamber 202.

The process chamber 202 also comprises conventional systems for retaining and releasing the substrate 226, performing internal diagnostics, and the like. Such systems are collectively depicted in FIG. 2 as support systems 240.

The remote plasma source 206 may include a power source 246, a gas panel 244, and a remote plasma chamber 242. In some embodiments, the power source 246 comprises a radio-frequency (RF) generator 248, a tuning assembly 250, and an applicator 252. The RF generator 248 is capable of producing of about 200 to 8000 W at a frequency of about 200 to 600 kHz. The applicator 252 is inductively coupled to the remote plasma chamber 242 and energizes a process gas (or gas mixture) 264 to a plasma 262 in the remote plasma chamber 242. In this embodiment, the remote plasma chamber 242 has a toroidal geometry that confines the plasma and facilitates efficient generation of radical species, as well as lowers the electron temperature of the plasma. In some embodiments, the remote plasma source 206 may be a microwave plasma source, however, stripping rates may be higher using the inductively coupled remote plasma.

The gas panel 244 uses a conduit 266 to deliver the process gas to the remote plasma chamber 242. The gas panel 244 (or conduit 266) may include systems (not shown), such as mass flow controllers, shut-off valves, and the like, to control gas pressure and flow rate for each individual gas supplied to the remote plasma chamber 242. In the plasma 262, the process gas is ionized and dissociated to form reactive species.

The reactive species are directed into the mixing volume 222 through an inlet port 268 in the lid 218. To minimize charge-up plasma damage to devices on the substrate 226, the ionic species of the process gas are substantially neutralized within the mixing volume 222 before the gas reaches the reaction volume 224 through a plurality of openings 270 in the showerhead 220.

The process gases and/or byproducts may be optically coupled to the IRS system 290 for monitoring, as discussed above. In some embodiments, the sidewall 216 may include a port 294 for coupling process gases and/or byproducts into the IRS system 290 (for example, for coupling the IRS system 290 to the interior volume of the process chamber 202). Although shown in FIG. 2 as being disposed in one particular location in the sidewall 216, the port 294 (and the IRS system 290) may be disposed in other locations in the sidewall 216 or in other locations of the process chamber 202, such in or proximate to the exhaust port 236, in an exhaust line of the process chamber 202 between the exhaust port 236 and the pump 214, or other suitable location.

The IRS system 290 generally includes an IR source and an IR detector configured with respect to each other such that the IR source directs IR radiation into the process gases or byproducts and the IR detector can detect the amount of IR radiation absorbed and/or transmitted by the process gases and/or byproducts. The IR source may be any suitable source of IR radiation in a desired wavelength or band of wavelengths, such as such as a broadband or white light source, a laser IR source for emitting radiation at one or more IR wavelengths, or the like. The IR detector may be any suitable detector for detecting IR radiation and/or calculating resulting molecular absorption and transmission between suitable ranges, for example about 1350 to about 5000 cm⁻¹. The IR detector may further have a resolution of, for example, between about 2 and about 64 cm⁻¹. Examples of suitable IR detectors include monochromators that can be set to monitor the IR radiation absorbed at particular wavelengths within the entire spectrum, hardware based on bandwidth filter(s), spectrometers (e.g., such as a Fourier transform IR (FTIR) spectrometer), or the like. In some embodiments, the apparatus 290 can detect IR radiation at one or more particular wavelengths between about 1300-4200 cm⁻¹. One exemplary spectrometer that may be utilized is the InDuct™ FTIR gas detector manufactured by MKS instruments of Wilmington, Mass.

In some embodiments, the IRS system 290 may be configured to sample process gases and/or byproducts from the process chamber 202 (for example, via the port 294, as shown in FIG. 2). In some embodiments (not shown), the IRS system 290 may be configured to direct the IR radiation into the process chamber 202 and detect the IR radiation absorbed/transmitted by the process gases and/or byproducts within the process chamber 202 (for example, through an IR transparent window—such as quartz). In such embodiments, the IR detector may also detect the transmitted IR radiation through the same, or a different, transparent window to detect the quantity of IR radiation absorbed/transmitted by the process gases and/or byproducts. Optical devices such as lenses, mirrors, collimators, or the like may be utilized to direct the IR radiation into and/or out of the process chamber 202.

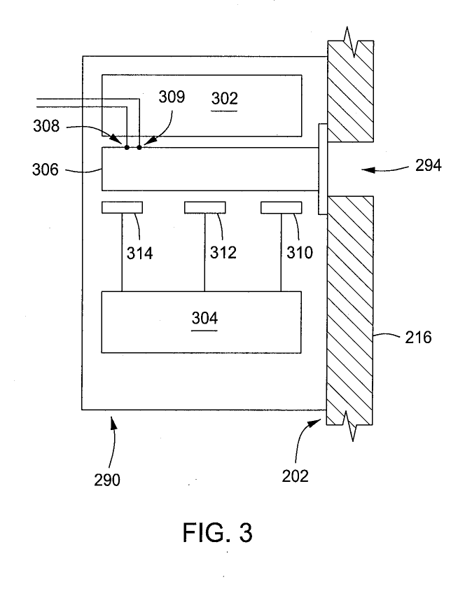

One exemplary, non-limiting embodiment of the IRS system 290 is illustrated in FIG. 3. In some embodiments, the IRS system 290 may include an infrared radiation (IR) source 302, an IR detector 304, and a gas cell 306. As shown in FIG. 3, the gas cell 306 may be disposed external to the process chamber 202. For example, the gas cell 306 may have a flange that is coupled to wall 216 of the process chamber 202 to align the gas cell 306 with the port 294 for receiving byproducts from the process chamber 202. The gas cell 306 may comprise any suitable material transparent to IR radiation such as quartz or optical glass, or may include windows of such transparent materials to facilitate coupling IR radiation into and out of the gas cell 306. A pressure transducer 308 and a thermocouple 309 may be provided to monitor the pressure and temperature, respectively of the gas cell 306.

The IR source 302 and IR detector 304 are disposed on opposing sides of the gas cell 306. The IR source 302 may be any suitable IR source as discussed above. The IR detector 304 detects a quantity of IR radiation that is transmitted through the process gas and/or byproducts disposed in the gas cell 306. In some embodiments, and as illustrated in FIG. 3, the IR detector 304 may have one or more, such as two, or three, bandpass filters 310, 312, and 314 coupled thereto. In such an embodiment, two of the bandpass filters 310, 312 may allow the passage of wavelengths for CO and CO₂, respectively. In some embodiments, an optional third bandpass filter 314 may be a neutral density filter for background calibration. Different, and/or additional filters may be included as necessary for measuring IR radiation absorbed by additional process gases and/or byproducts of the removal process.

In operation, process gases and/or byproducts from the removal process may flow (e.g., may diffuse) into the gas cell 306 via the port 294. IR radiation may be directed from the IR source 302 into the gas cell 306, and may be partially absorbed by the process gases and/or byproducts disposed in the cell 306. The portion of the IR radiation remaining after absorption is detected by the detector unit 304. In some embodiments, the flowing process gases and/or byproduct gases may be sampled to establish an endpoint trace. In some embodiments, the sampling may occur at a rate of about 10 Hz, although other sampling rates may be utilized. The distance the IR radiation travels between entering the cell 306 and exiting the cell 306 is defined as the pathlength of the IR radiation. For example, in the IRS system 290 illustrated in FIG. 3, the pathlength is the diameter, or width of the gas cell 306. In some embodiments, the pathlength may be increased by reflecting the IR radiation within the cell 306 such that the IR radiation travels a longer path between entering and exiting the cell 306. The pathlength may be increased, for example, by having one or more mirrors disposed about the cell 306 for reflecting IR radiation, or coating the cell with a reflective or semi-reflective material.

The above embodiments of the IRS system 290 are exemplary, and other configurations may be utilized. For example, the IR source and IR detector may be aligned on opposing sides of the process chamber and optically coupled to the process gases and/or byproduct within the chamber via IR transparent windows (e.g., the IR source may direct IR radiation into the process chamber and the IR detector may be disposed on an opposite side of the process chamber and configured to detect the IR radiation after it passes through the process gases and byproducts contained within the chamber). The IR source and IR detector may also be disposed on the same side of the process chamber or otherwise out of direct alignment and may utilize mirrors, lenses, collimating optics or the like to direct the IR radiation into the process chamber and back to the detector unit.

Returning to FIG. 2, the controller 208 comprises a central processing unit (CPU) 254, a memory 256, and support circuits 258. The CPU 254 may be any form of a general-purpose computer processor used in an industrial setting. Software routines can be stored in the memory 256, such as random access memory, read only memory, floppy or hard disk, or other form of digital storage. The support circuits 258 are conventionally coupled to the CPU 254 and may comprise cache, clock circuits, input/output sub-systems, power supplies, and the like.

The software routines, when executed by the CPU 254, transform the CPU into a specific purpose computer (controller) 208 that controls the reactor 200 such that processes are performed in accordance with the present invention (e.g., the method 100 of FIG. 1). The software routines may also be stored and/or executed by a second controller (not shown) that is located remotely from the reactor 200.

Thus, methods for endpoint detection in a strip/passivation chamber having a remote plasma source have been provided herein. The inventive methods may advantageously allow for the end point detection of a photoresist removal process by monitoring the IR radiation absorbed by byproducts of the removal process. This method of detection may be advantageous in a chamber having a remote plasma source because the byproducts of the removal processes are in a non excited state and thus cannot be detected by other means such as optical emission.

While foregoing is directed to embodiments of the present invention, other and further embodiments of the invention may be devised without departing from the basic scope thereof.

1. A method for determining an endpoint of a photoresist removal process, comprising:
removing a photoresist from a substrate disposed in a process chamber using reactive species provided to the process chamber from a remote plasma source;
directing infrared radiation into the at least one of the reactive species or process byproducts while removing the photoresist;
monitoring a quantity of infrared radiation absorbed by at least one of the reactive species or process byproducts during the removal process; and
ending the photoresist removal process based upon the monitored quantity reaching a predetermined level.

2. The method of claim 1, wherein the infrared radiation is generated by an infrared radiation source including a broadband or laser source.

3. The method of claim 1, further comprising:
an infrared radiation apparatus having an infrared radiation source and an infrared radiation detector coupled to a gas cell, wherein the gas cell is coupled to the process chamber and configured to receive at least one of the reactive species or process byproducts therein.

4. The method of claim 1, further comprising:
an infrared radiation apparatus having an infrared radiation source for providing infrared radiation and an infrared radiation detector for detecting a quantity of infrared radiation absorbed by the at least one of the reactive species or process byproducts.

5. The method of claim 4, wherein the infrared radiation apparatus detects a wavelength range of about 1300-4200 cm⁻¹.

6. The method of claim 4, wherein the infrared radiation apparatus further comprises two or more bandpass filters.

7. The method of claim 6, wherein the two or more filters include a first bandpass filter for a first wavelength range and a second bandpass filter for a second wavelength range.

8. The method of claim 7, wherein the first wavelength range Is between about 2000-2300 cm1, the second wavelength range Is between about 2200-2400 cm-1.

9. The method of claim 8, further comprising a third bandpass filter for a third wavelength range selected to filter out background noise.

10. The method of claim 1, wherein monitoring the quantity of infrared radiation absorbed further comprises sampling the infrared radiation absorbed at a desired frequency.

11. The method of claim 10, wherein the desired frequency is about 1 Hz.

12. The method of claim 1, wherein the infrared radiation of byproducts including at least one of CO (carbon monoxide), CO₂ (carbon dioxide), or H₂O (water) are monitored.

13. The method of claim 1, wherein the infrared radiation of reactive species including at least one of N₂ (nitrogen), O₂ (oxygen), or H₂O (water) are monitored.

14. The method of claim 1, wherein directing infrared radiation into the process chamber further comprises directing infrared radiation into a processing volume of the process chamber or directing infrared radiation into an exhaust line of the process chamber.

15. The method of claim 1, wherein the chamber pressure ranges from about 1 mTorr to about 100 Torr.

16. The method of claim 1, wherein the infrared radiation is supplied at a power of up to about 8000 Watts.

17. The method of claim 1, wherein a wavelength of infrared radiation absorbed by the byproducts is monitored between about 2000-2300 cm⁻¹.

18. The method of claim 1, wherein a wavelength of infrared radiation absorbed by the byproducts is monitored between about 2200-2400 cm⁻¹.

19. The method of claim 1, wherein a wavelength of infrared radiation absorbed by the byproducts is monitored between about 2000-2400 cm⁻¹.

20. The method of claim 1, further comprising:
altering the process photoresist removal process based upon the monitored quantity reaching a second predetermined level prior to ending the photoresist removal process.
